(19) United States
(12) Patent Application Publication
(10) Pub. No.: US 2026/0076863 A1
(43) Pub. Date: Mar. 19, 2026

(54) MASSAGE DEVICE AND DRIVING UNIT FOR THE MASSAGE DEVICE

(71) Applicant: Xiamen Healthpal Electronic Co., Ltd, Xiamen (CN)

(72) Inventors: Ying CHEN, Xiamen (CN); Qixian LIN, Xiamen (CN)

(21) Appl. No.: 18/918,291

(22) Filed: Oct. 17, 2024

(30) Foreign Application Priority Data
Sep. 13, 2024 (CN) 202422249450.6

(51) Int. Cl. A61H 7/00

(52) U.S. Cl. CPC A61H 7/004; A61H 7/007; A61H 2201/0134; A61H 2201/1215; A61H 2203/0456; A61H 2205/02; A61H 2205/04

(57) ABSTRACT

A massage device, comprising: a massage unit comprising at least one first massage member configured for massaging a neck of a user and at least one second massage member configured for massaging a head of the user; and a driving unit configured to be coupled to the at least one first massage member and the at least one second massage member, the driving unit being capable of driving the at least one first massage member and the at least one second massage member to do synchronous motions.

### TECHNICAL FIELD

The present application relates to the general field of therapeutic devices, and more specifically to a massage device that can be laid on the floor or any flat surface to function.

### BACKGROUND

Massage has been proven to be one of the best ways to fix a number of health challenges, particularly for users who deal with neck or head pain. While beneficial, massage therapy can be prohibitively expensive. Thus, people without medical insurance that covers massage, affording the massage treatment can be a challenge.

Massage machine is becoming more and more popular, it is widely used to alleviate muscle pains. There are many types of massage devices available on the market, such as, a portable massager which can be used for massaging a specific part of the human body, a massage chair which can be used for massaging the whole body of the human body. However, a massage chair may be too big and inconvenient to be placed in a room and a portable massager needs the user to apply force to it. Therefore, a massaging device capable of massaging a user, without needing additional helpers and without need the user to apply effort or force to the device may be needed.

### BRIEF DESCRIPTION OF DRAWINGS

FIG. 1 is a perspective view illustrating a massage device of an embodiment of the present invention.

FIG. 2 is an exploded view illustrating the massage device of the present embodiment shown in FIG. 1.

FIG. 3 is a perspective view for illustrating a portion of a driving unit of the massage device of the present embodiment.

FIG. 4 is an orthographic projection view illustrating the driving unit of the massage device of the present embodiment viewed from a top side.

FIG. 5 is a view illustrating the massage device in use.

### DETAIL DESCRIPTION

In the description that follows, numerous details are outlined to provide a thorough understanding of the present invention. It will be appreciated by those skilled in the art that variations of these specific details are possible while still achieving the results of the present invention.

Exemplary illustrative embodiments of the invention should be interpreted as example(s) and non-limiting. The relationship between various elements, where they are located, their composition(s), their operation and sometimes their sizes relative to the desired operation of the invention are significant.

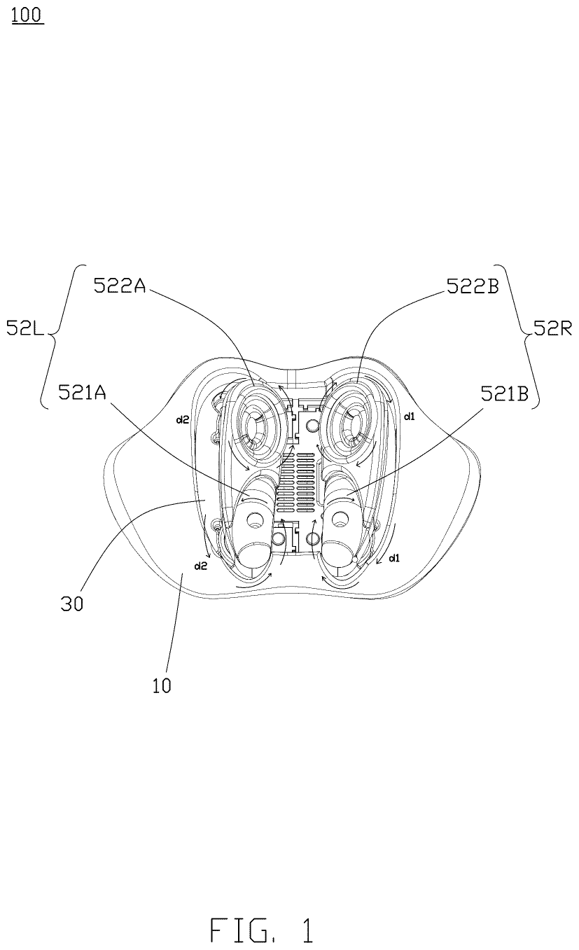

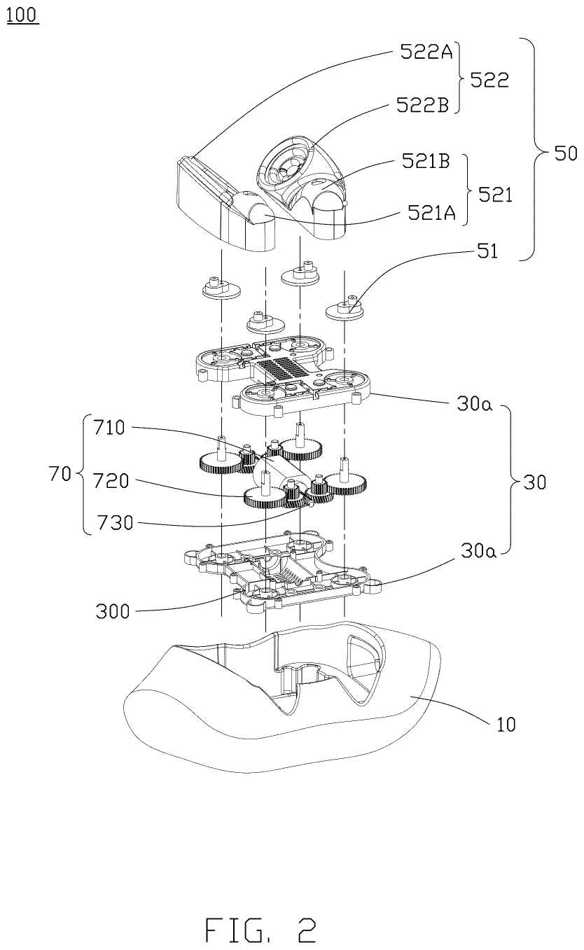

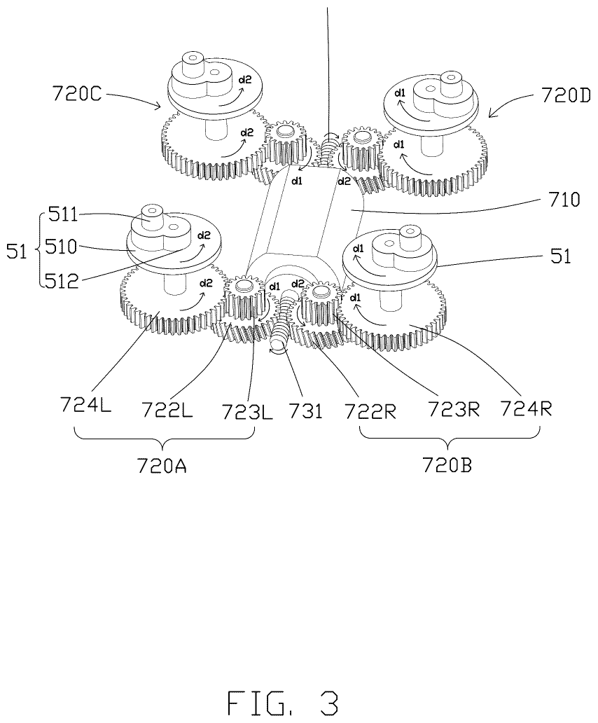

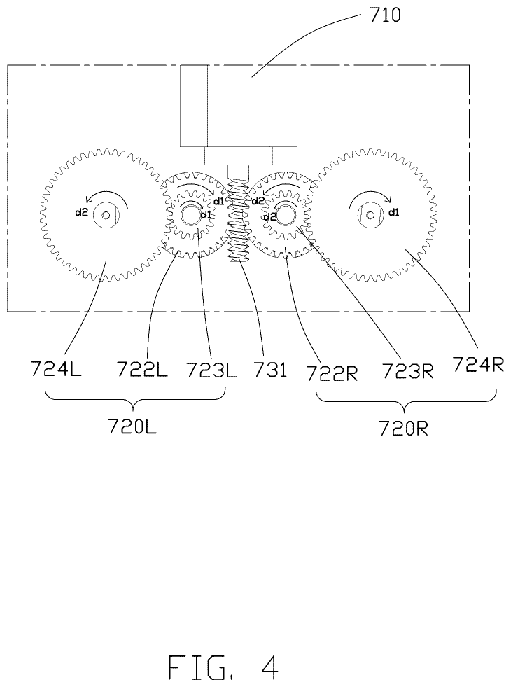

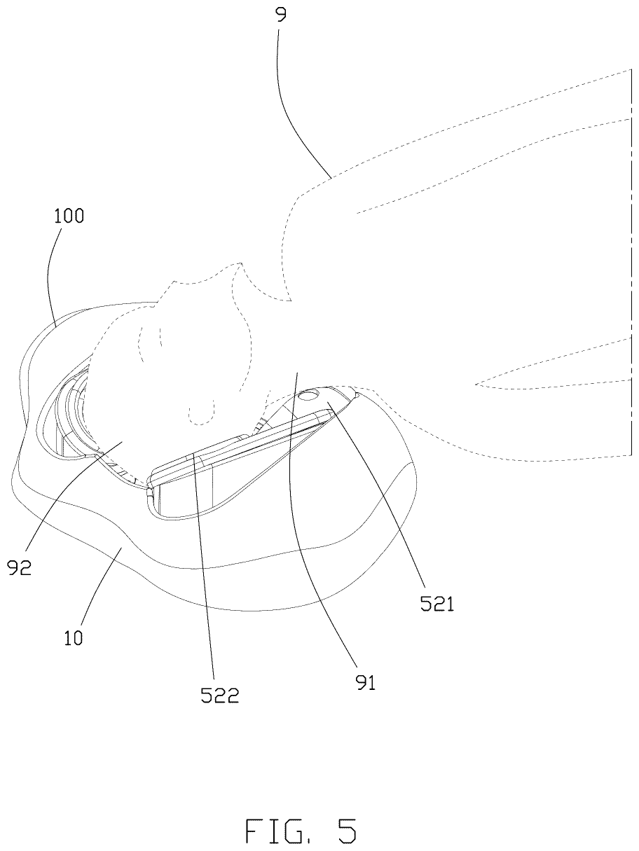

Referring to FIGS. 1 to 5, which illustrate a massage device 100 of an embodiment of the present invention. The massage device 100 may include a housing 30, a massage unit 50, and a driving unit 70. The massage device 100 may be configured in the shape of a pillow to be used as a massage pillow. The massage device 100 may include a cushioning body 10 which is made of cushion material, for example, containing sponge, for the massage pillow. At least a part (for example, side surfaces and a bottom surface) of the housing 30 is wrapped by the cushioning body 10. In an embodiment, a groove is defined in the cushioning body 10, and the housing 30 is received in the groove. The massage device 100 is configured to be laid on the floor or any other flat surface to massage a user 9. For example, the massage device 100 is placed on a bed or floor. Referring to FIG. 5, the user 9 can lie on the bed or floor with user's head 92 and neck 91 being placed on the massager.

The housing 30 includes an upper housing 30a and a lower housing 30b. The upper housing 30a and the lower housing 30b cooperate to define an accommodating space 300. The driving unit 70 is accommodated in the accommodating space 300. The massage unit 50 is mounted on an upper surface of the upper housing 30a of the housing 30. An opening is defined in the upper surface of the upper housing 30a. The driving unit 70 is coupled to the massage unit 50 through the opening of the upper housing 30a of the housing 30.

The driving unit 70 is disposed in the accommodating space 300 and includes a driving portion 710 and a gear set unit 720. In this embodiment, the gear set unit 720 includes a first gear set 720A, a second gear set 720B, a third gear set 720C, and a fourth gear set 720D.

The driving portion 710 includes a motor capable of converting electrical energy into mechanical energy and a rotating shaft 730 attached to the motor for rotationally outputting the mechanical energy. The rotating shaft 730 is connected to the gear set unit 720 and connected to the massage unit 50 by the transmission of the gear set unit 720. In this embodiment, the rotating shaft 730 includes a first rotating shaft 731 and a second rotating shaft 732 in axially opposite directions. The first rotating shaft 731 and the second rotating shaft 732 are disposed at two opposite ends of the motor, so as to act as outputs of the driving portion 710. The first rotating shaft 731 and the second rotating shaft 732 are provided with helical teeth, and rotatable when driven by the driving portion 710. The first rotating shaft 731 and the second rotating shaft 732 may be worms. The helical teeth of the first rotating shaft 731 and the second rotating shaft 732 may have the same tilt direction, so as to produce driving forces with the same direction onto two different components of the massage unit 50, symmetrically. In another embodiment, the helical teeth of the first rotating shaft 731 and the second rotating shaft 732 may have opposite tilt directions, so as to produce driving forces with opposite directions onto two different components of the massage unit 50, symmetrically.

The first gear set 720A and the second gear set 720B are engaged to two opposite sides of an outer peripheral surface of the first rotating shaft 731 in a transmission mode. The third gear set 720C and the fourth gear set 720D are engaged to two opposite sides of an outer peripheral surface of the second rotating shaft 732 in the transmission mode. Moreover, the first gear set 720A and the second gear set 720B are symmetrically connected to opposite sides of one end of an axial direction of the driving portion 710 in the transmission mode, and the third gear set 720C and the fourth gear set 720D are symmetrically connected to opposite sides of the other end of the axial direction of the driving portion 710 in the transmission mode.

In this embodiment, the driving portion 710 is disposed in the housing 30. The first rotating shaft 731 and the second rotating shaft 732 are parallel to the bottom surface of the housing 30, but is not limited to this, and is capable of being disposed according to actual needs.

The first gear set 720A is connected a tooth surface on one side of the first rotating shaft 731 in an engaged mode. In this embodiment, the first gear set 720A includes a first gear 722L as an input gear, a second gear 723L, and a third gear 724L as an output gear. In the top view, respective rotating shafts of the first gear 722L, the second gear 723L, and the third gear 724L are disposed vertically through an arrange plan of the gears 722L, 723L, 724L, but are not limited to this, and are capable of being disposed according to actual needs. The first gear 722L is connected to the tooth surface on one side of the first rotating shaft 731 in an engaged mode, the second gear 723L is fixedly connected to the first gear 722L, the second gear 723L is connected to the third gear 724L in an engaged mode, and the third gear 724L is used for being fixedly connected to the massage unit 50. The first gear 722L may be a gear and the first rotating shaft 731 may be a worm, such that the first gear 722L may be connected to the first rotating shaft 731 in a gear and worm mode. The second gear 723L and the first gear 722L may be connected to different planes in a coaxial and synchronous rotation manner, and the first gear 722L and the second gear 723L may form, for example, duplex gears. The size of the first gear 722L is set to be greater than that of the second gear 723L, such that the second gear 723L can reduce an output rotational speed. The size of the third gear 724L may be set to be greater than that of the second gear 723L, such that the third gear 724L can further reduce the output rotational speed, but it is not limited to this, it is capable of being designed according to actual needs. In addition, the number of gears included in the first gear set 720A is not limited to three, it can be set arbitrarily according to the accommodating space 300.

The second gear set 720B is connected to a tooth surface on the other side of the first rotating shaft 731 in an engaged mode. In this embodiment, the second gear set 720B includes a first gear 722R as an input gear, a second gear 723R, and a third gear 724R as an output gear. The first gear 722R, the second gear 723R, and the third gear 724R included in the second gear set 720B and the first gear 722L, the second gear 723L, and the third gear 724L included in the first gear set 720A are consistent in composition, except that they are symmetrically and oppositely positioned with respect to the driving portion 710 (i.e., symmetrical to each other on left and right sides), and herein, only suffixes are used to denote a difference between them. In addition, the suffixes thereof are omitted for description when they are referred to collectively. In other words, in the top view, respective rotating shafts of the first gear 722R, the second gear 723R, and the third gear 724R are disposed vertically, but are not limited to this, and are capable of being disposed according to actual needs. The first gear 722R is connected to the tooth surface on one side of the first rotating shaft 731 in an engaged mode, a shaft of the second gear 723R is fixedly connected to a shaft of the first gear 722R, the second gear 723R is connected to the third gear 724R in an engaged mode, and the third gear 724R is used for being fixedly connected to the massage unit 50. The first gear 722R may be a worm gear and the first rotating shaft 731 may be a worm, such that the first gear 722R may be connected to the first rotating shaft 731 in a worm gear and worm mode. The second gear 723R and the first gear 722R may be connected to different layers in a coaxial and synchronous rotation manner, and the first gear 722R and the second gear 723R may form, for example, duplex gears. The size of the first gear 722R is set to be greater than that of the second gear 723R, such that the second gear 723R can reduce an output rotational speed. The size of the third gear 724R may be set to be greater than that of the second gear 723R, such that the third gear 724R can further reduce the output rotational speed. In addition, the number of gears included in the second gear set 720B is not limited to three, it can be set arbitrarily according to the accommodating space 300.

Since the first gear 722L and the first gear 722R are connected to the opposite tooth surfaces of the first rotating shaft 731 in the engaged mode, the first gear 722L and the first gear 722R rotate in opposite directions, and the first gear 722L drives the second gear 723L to rotate in the same direction, and the second gear 723L drives the third gear 724L to rotate in the opposite directions, and the first gear 722R drives the second gear 723R to rotate in the same direction, and the second gear 723R drives the third gear 724R to rotate in the opposite direction, with the result that the third gear 724R and the third gear 724L rotate in opposite directions to each other.

In the housing 30, the driving portion 710 is disposed horizontally, and the rotating shaft of each gear of the gear set unit 720 is disposed vertically, such a placement manner is favorable to reduce a height dimension of the housing 30. When the massage device 100 is used for a head 92 and/or a neck 91 massage and placed below the head 92 and/or neck 91 of the user 9, it is possible to avoid the problem that because the massage device 100 is too high, discomfort is caused to the user 9.

In addition, the third gear set 720C and the fourth gear set 720D are connected to opposite tooth surfaces of the second rotating shaft 732 in an engaged mode and are symmetrical on left and right sides of the driving portion 710. Moreover, a composition of the third gear set 720C is the same as that of the first gear set 720A on one side of the first rotating shaft 731, and a composition of the fourth gear set 720D is the same as that of the second gear set 720B on one side of the first rotating shaft 731. That is, the third gear set 720C is provided with a first gear 722L, a second gear 723L, and a third gear 724L same as those of the first gear set 720A, and the fourth gear set 720D is provided with a first gear 722R, a second gear 723R, and a third gear 724R same as those of the second gear set 720B. Therefore, detailed description is omitted here.

The massage unit 50 includes at least one first massage member 521, at least one second massage member 522, and a plurality of transmission connection pieces 51. The at least one first massage member 521 includes a pair of first massage portions [symbol] i.e. neck massage portions [symbol] 521A and 521B, the at least one first massage member 522 includes a pair of second massage portions [symbol] i.e. head massage portions [symbol] 522A and 522B. The first massage portions 521A and 521B are configured and shaped for massaging neck 91 of the user 9 and the second massage portions 522A and 522B are configured and shaped for massaging head 92 of the user 9, while the user 9 lies on the massage device 100. The first gear set 720A, the second gear set 720B, the third gear set 720C, and the fourth gear set 720D are connected to the pair of first massage portions 521A and 521B and the pair of second massage portions 522A and 522B, respectively, via the transmission connection pieces 51. Thus, the massage unit 50 is driven to do a swing motion.

All the transmission connection pieces 51 are disposed above the output gears (such as, the third gear 724L and the third gear 724R) of all the gear sets 720A to 720D and used for connecting all the gear sets 720A to 720D to the pair of first/second massage portions 521A, 521B, 522A and 522B.

In this embodiment, the transmission connection piece 51 is designed of an eccentric wheel structure, which includes a wheel disk 510 and a first connection portion 511 and a second connection portion 512 disposed on the wheel disk 510. The second connection portion 512 is disposed coaxially with the wheel disk 510 and is fixedly connected to shafts of the output gears of all the gear sets 720A to 720D through the wheel disk 510. The first connection portion 511 disposed deviating from the second connection portion 512 is fixedly connected to the pair of first massage portions 521A and 521B and the pair of second massage portions 522A and 522B. As a result, when the output gears (the third gear 724L and the third gear 724R) of all the gear sets 720A to 720D rotate, the second connection portion 512 and the output gears of the gear sets 720A to 720D coaxially and synchronously rotate, and the first connection portion 511 circulates around the second connection portion 512. Accordingly, driven by the driving portion 710, all the gear sets 720A to 720D drive the transmission connection piece 51 to rotate, and furthermore, the transmission connection piece 51 drives one of the pair of first massage portions 521A and 521B moves clockwise while the other moves counterclockwise, and at the same time, one of the pair of second massage portions 522A and 522B to moves clockwise while the other moves counterclockwise. The movement of the first massage portions 521A and 521B and the second massage portions 522A and 522B is sometimes referred to as deflected swing movement.

The pair of first massage portions 521A and 521B are symmetrical to each other. The pair of first massage portions 521A and 521B may have two protrusions on left and right sides. The first and the second massage portions 521A and 522A located on left side are collectively referred to as left-side massage component 52L. The first and the second massage portions 521B and 522B located on right side are collectively referred to as right-side massage component 52R. The pair of second massage portions 522A and 522B are symmetrical to each other. The pair of second massage portions 522A and 522B may have two recesses formed on the left and right sides. The first and the second massage portions 521A and 522A are attached to a first base which is long strip shaped, the first and the second massage portions 521B and 522B are attached to a second base which is long strip shaped. In use, the head 92 of the user 9 is placed on the second massage portions 522A and 522B, while the neck 91 of the user 9 is placed on the first massage portions 521A and 521B. The head 92 and neck 91 of the user 9 are wrapped and supported by the pair of first massage portions 521A and 521B and the pair of second massage portions 522A and 522B. Flexible members, such as silica gel, is contained in the recesses of the second massage portions 522A and 522B, which can be flexibly deformed when massaging the head of the user to improve the comfort of the user 9 while avoiding displacement generated during massage and avoiding the problem of a weak massage effect caused by inaccurate massage alignment.

The protrusions of the first massage portions 521A and 521B can simulate the kneading action of human hands during the deflected swing movement, so as to improve the massage effects. The recesses of the second massage portions 522A and 522B can simulate the kneading action of human palms during the deflected swing movement, so as to improve the massage effect.

The first massage portion 521A, 521B are disposed on left and right sides of the driving portion 710, they are movable along opposite directions in the deflected swing mode. The second massage portion 522A, 522B are disposed on the left and right sides of the driving portion 710, they are movable in opposite directions in the deflected swing mode. In addition, the deflected swing movements of the pair of first massage portions 521A and 521B and the pair of second massage portions 522A and 522B are synchronously performed. The first and the second massage portions 521A and 522A both of which are located at the left side are capable of swing synchronously along same directions. The first and the second massage portions 521B and 522B both of which are located at the right side are capable of swing synchronously along same directions. In another embodiment, the first and the second massage portions 521A and 522A both of which are located at the left side are capable of swing synchronously along opposite directions. The first and the second massage portions 521B and 522B both of which are located at the right side are capable of swing synchronously along opposite directions. Therefore, the first massage portions and the second massage portions 521A are capable of swinging from left to right for massage.

In addition, the first and the second massage portions 521A and 522A may be two independent components or an integrated component. The first and the second massage portions 521B and 522B may be two independent components or an integrated component. In the case where the first and the second massage portions 521A and 522A are two independent components, and the first and the second massage portions 521B and 522B are two independent components, sizes, rotation directions, and positions of the gears of the third gear set 720C and the fourth gear set 720D on the sides of the second rotating shaft 732 can be different to those of the gears of the first gear set 720A and the second gear set 720B on the sides of the first rotating shaft 731, as long as the two gear sets on the two sides of the same output shaft are symmetrical to each other. In addition, in the case where the first and the second massage portions 521A and 522A are split, and the first and the second massage portions 521B and 522B are two independent components, relative positions and distance between the first connection portion 511 and the second connection portion 512 in the transmission connection piece 51 which is connected to the first massage portion 521A may have different to those of the transmission connection piece 51 which is connected to the second massage portion 522A. Furthermore, relative positions and distance between the first connection portion 511 and the second connection portion 512 in the transmission connection piece 51 which is connected to the first massage portion 521A may be different to those of the transmission connection piece 51 which is connected to the second massage portion 522A. In addition, the relative positions and distances between the first connection portion 511 and the second connection portion 512 in two transmission connection pieces 51 connected to the same output shaft can be symmetrical along the driving portion 710 according to a required massage mode, such that the massage portions connected to the same output shaft can perform symmetrical massage actions. In another embodiment, it can also perform asymmetrical massage actions by simply changing the relative positions of the first connection portion 511 and the second connection portion 512.

When the massage device is used, the driving portion 710 drives the output gears of the gear sets to rotate by means of the rotating shaft 730. Due to connection on opposite sides of the outer peripheral surface of the first rotating shaft 731, teeth on the left side of the first rotating shaft 731 push teeth on the right side of the first gear 722L to rotate, and at the same time, teeth on the right side of the first rotating shaft 731 also push teeth on the left side of the first gear 722R to rotate, whereby the first gear 722L rotates clockwise while the first gear 722R rotates counterclockwise, or, whereby the first gear 722L rotates counterclockwise while the first gear 722R rotates clockwise. On the left side, the second gear 723L moves in the same way as the first gear 722L, if the first gear 722L rotates clockwise (i.e., along a direction d1), the second gear 723L rotates clockwise (i.e., along the direction d1) and then drives the third gear 724L to rotate counterclockwise (i.e., along a direction d2 which is opposite to the direction d1). Next, the transmission connection piece 51 connected to the third gear 724L rotates counterclockwise (i.e., along the direction d2) and drives the first massage portion 521A (or the second massage portion 522A) to move counterclockwise (i.e., along the direction d2). On the right side, the second gear 723L moves in the same way as the first gear 722L, if the first gear 722L rotates counterclockwise (i.e., along the direction d2), the second gear 723L rotates counterclockwise (i.e., along the direction d2) and then drives the third gear 724L to rotate clockwise (i.e., along the direction d1). Next, the transmission connection piece 51 connected to rotate clockwise (i.e., along the direction d1) and drives the first massage portion 521B (or the second massage portion 522B) to move clockwise (i.e., along the direction d1). In the case where the first connection portion 511 and the second connection portion 512 in the transmission connection piece 51 which is connected to the first gear set 720A are respectively symmetrical to the first connection portion 511 and the second connection portion 512 in the transmission connection piece 51 which is connected to the second gear set 720B. The first connection portion 511 of one transmission connection piece 51 moves clockwise (i.e., along the direction d1) around the second connection portion 512, the first connection portion 511 of another transmission connection piece 51 moves symmetrically counterclockwise (i.e., along the direction d2) around the second connection portion 512. Similarly, while the first connection portion 511 of one transmission connection piece 51 in the two transmission connection pieces 51 connected to the third gear set 720C and the fourth gear set 720D moves clockwise (i.e., along the direction d1) around the second connection portion 512, the first connection portion 511 of another transmission connection piece 51 moves symmetrically counterclockwise (i.e., along the direction d2) around the second connection portion 512. As a result, driven by the transmission connection piece 51, the first massage portions 521A and 521B and the second massage portions 522A and 522B follow first connection portion 511 to perform the deflecting swing movement, the first massage portions 521A and 521B are symmetrical to each other on the left and right sides, and the second massage portions 522A and 522B are symmetrical to each other on the left and right sides, so as to be able to make kneading and squeezing massage actions.

What is claimed is:

1. A massage device comprising:
a massage unit comprising at least one first massage member configured for massaging a neck of a user; and at least one second massage member configured for massaging a head of the user; and
a driving unit configured to be coupled to the at least one first massage member and the at least one second massage member, the driving unit configured for driving the at least one first massage member and the at least one second massage member to move synchronously.

2. The massage device according to claim 1, wherein the at least one second massage member comprises two second massage portions which are symmetrical to each other, and the two second massage portions respectively move in opposite directions,
the at least one first massage member comprises two first massage portions which are symmetrical to each other, and the two first massage portions respectively move in the opposite directions.

3. The massage device according to claim 1, wherein the massage unit further comprises at least one first transmission connection piece and at least one second transmission connection piece,
the at least one first transmission connection piece is configured to couple with the driving unit and the at least one first massage member,
the at least one second transmission connection piece is configured to couple with the driving unit and the at least one second massage member,
the at least one first transmission connection piece and the at least one second transmission connection piece are respectively disposed at opposite sides of the driving unit.

4. The massage device according to claim 2, wherein the two first massage portions are protrusions, the two second massage portions are recesses, and the two first massage portions and the two second massage portions cooperatively wrapping the head and the neck in a use state.

5. The massage device according to claim 2, wherein a first massage portion of the two first message portions on a side of the massage unit and a second massage portion of the two second message portions on the side of the massage unit are integrated together.

6. The massage device according to claim 1, wherein the driving unit comprises a driving portion and a gear set unit,
the driving portion comprises a rotating shaft, the rotating shaft rotates when the driving portion is electrically powered,
the gear set unit is respectively connected to the rotating shaft of the driving portion in a transmission mode and connected to the massage unit in the transmission mode, wherein the gear set unit is driven by the driving portion, so as to drive the massage unit to move in a deflecting swing mode.

7. The massage device according to claim 6, wherein the rotating shaft comprises a first rotating shaft and a second rotating shaft, the first and the second rotating shafts are respectively arranged in axially opposite directions,
the gear set unit comprises a first gear set, a second gear set, a third gear set, and a fourth gear set,
the first gear set and the second gear set are symmetrically connected to opposite sides of a peripheral surface of the first rotating shaft,
the third gear set and the fourth gear set are symmetrically connected to opposite sides of a peripheral surface of the second rotating shaft.

8. The massage device according to claim 7, wherein the massage unit further comprises two first transmission connection piece and two second transmission connection piece,
the two first transmission connection pieces are configured to couple with the driving unit and the at least one first massage member,
the two second transmission connection pieces are configured to couple with the driving unit and the at least one second massage member,
the two first transmission connection pieces and the two second transmission connection pieces are respectively disposed at opposite sides of the driving unit,
the two first transmission connection pieces are configured to couple with the first and the second gear sets in the transmission mode respectively, so that one of the two first transmission connection pieces rotates in a first direction, and the other one of the two first transmission connection pieces rotates in a second direction opposite to the first direction,
the third and the fourth transmission connection pieces are configured to couple with the third and the fourth gear sets in the transmission mode respectively, so that the third transmission connection piece is driven to rotate in the first direction and the fourth transmission connection piece is driven to rotate in the second direction.

9. The massage device according to claim 8, wherein each of the transmission connection pieces comprise a wheel disk, a first connection portion and a second connection portion disposed on the wheel disk,
the second connection portion is disposed coaxially with the wheel disk and rotationally connected to the gear set unit,
the first connection portion is disposed deviating from the second connection portion, and is fixedly connected to the first massage member and the second massage member,
when the second connection portion rotates, the first connection portion circulates around the second connection portion and drives a corresponding first massage member or a corresponding second massage member to move.

10. The massage device according to claim 1, wherein the massage device further comprises a housing and a cushioning body,
the housing forms an accommodating space configured for accommodating the driving unit, the massage unit is mounted on an upper surface of the housing,
at least a portion of the housing is surrounded by the cushioning body.

11. The massage device of claim 1, wherein the second massage member comprises flexible members, the flexible member is configured to flexibly deformed when massaging the head of the user.

12. The massage device of claim 2, wherein one of the two second massage portions and one of the two first massage portions are located at a same side of the driving unit and swing synchronously along a same direction.

13. The massage device of claim 2, wherein one of the two second massage portions and one of the two first massage portions are located at a same side of the driving unit and respectively swing synchronously along opposite directions.

14. A driving unit configured for accommodating in a massage device, the drive unit comprising:
one driving portion comprising a first and a second rotating shafts respectively arranged in axially opposite directions; and
four gear sets driven synchronously by the one driving portion;
wherein the first rotating shaft and the second rotating shaft rotate when the driving portion is electrically powered,
two gear sets of the four gear sets are symmetrically connected to opposite sides of an outer peripheral surface of the first rotating shaft in a transmission mode, and other two gear sets of the four gear sets are symmetrically connected to opposite sides of an outer peripheral surface of the second rotating shaft in a transmission mode.

15. The drive unit of claim 14, wherein each of the four gear sets comprise an output gear,
one output gear of two output gears driven by the first rotating shaft rotates clockwise, and the other output gear of the two output gears rotates counterclockwise,
one output gear of other two output gears driven by the second rotating shaft rotates clockwise and the other output gear of the other two output gears rotates counterclockwise.

16. The drive unit of claim 15, wherein the first rotating shaft and the second rotating shaft are provided with helical teeth, the helical teeth of the first rotating shaft and the second rotating shaft have same tilt directions, and the first gear set and the third gear set rotate in the same direction.

17. The drive unit of claim 15, wherein the first rotating shaft and the second rotating shaft are provided with helical teeth, inclination of the helical teeth of the first rotating shaft is opposite to inclination of the helical teeth of the second rotating shaft, and the first gear set and the third gear set rotate in the opposite direction.

18. A massage device comprising:
a cushioning body configured to be laid on a flat surface;
a left-side massage component arranged on the cushioning body and comprising a first head massage portion for massaging a head; and
a right-side massage component arranged on the cushioning body and disposed at right side of the left-side massage component and aligned with the left-side massage component, the right-side massage component comprising a second head massage portion for massaging the head,
wherein the first head massage portion and the second head massage portion include recesses corresponding to massaging portions of the head.

19. The massage device of claim 18, wherein the left-side massage component further comprises a first neck massage portion for massaging a neck,
the right-side massage component further comprises a second neck massage portion for massaging the neck,
the second massage portions of the left-side massage component and the right-side massage component include protrusions corresponding to massaging portions of the neck.

20. The massage device of claim 19, wherein the left-side massage component is an integrated component, and the right-side massage component is an integrated component.
